(19) United States
(12) Patent Application Publication
(10) Pub. No.: US 2020/0085549 A1
(43) Pub. Date: Mar. 19, 2020

(54) INTERDENTAL CLEANING DEVICE AND METHOD FOR PRODUCING AN INTERDENTAL CLEANING DEVICE

(71) Applicant: LUORO GMBH, Köln (DE)

(72) Inventor: Louis Bahlmann, Köln (DE)

(21) Appl. No.: 16/617,079

(22) PCT Filed: May 15, 2018
(86) PCT No.: PCT/EP2018/062516

§ 371 Date: Nov. 26, 2019

(30) Foreign Application Priority Data
Jun. 2, 2017 (DE) 10 2017 209 389.7

(51) Int. Cl. A61C 15/00; A46B 5/02

(52) U.S. Cl. CPC A61C 15/00; A46B 2200/108; A46B 5/02

(57) ABSTRACT

The present invention relates to an interdental cleaning device having a one-piece, in particular injection-molded, base body that has a first leg and a second leg whose free ends are swivelable toward one another. On its free end the first leg has a positioning aid, in particular a cone, that protrudes toward a cleaning side and surrounds an opening in the first leg, and on its free end the second leg has a mounting for an interdental brush that is guidable through the opening. An elastic restoring element is situated between the first and the second leg, in a starting region of the legs situated opposite from the free ends of the legs. The invention further relates to a method for manufacturing this type of interdental cleaning device.

### Prior Art

The present invention relates to an interdental cleaning device having a one-piece, in particular injection-molded, base body that has a first leg and a second leg whose free ends are swivelable toward one another, wherein on its free end the first leg has a positioning aid, in particular a cone, that protrudes toward a cleaning side and surrounds an opening in the first leg, and on its free end the second leg has a mounting for an interdental brush that is guidable through the opening. The invention further relates to a method for manufacturing an interdental cleaning device, wherein a base body having a one-piece base body that has a first leg and a second leg whose free ends are swivelable toward one another is injection-molded, wherein on its free end the first leg has a positioning aid, in particular a cone, that protrudes toward a cleaning side and surrounds an opening in the first leg, and on its free end the second leg has a mounting for an interdental brush that is guidable through the opening.

This type of interdental cleaning device is known from WO 2016/174 263 A1, for example. The positioning aid of this interdental cleaning device is situated on a leg and provided with a coating made of a soft elastic plastic, thus allowing the interdental brush to be oriented on a space between the teeth in a manner that is gentle to the gums. The known interdental cleaning device also has a curved element that spans the two legs in the area of their free ends and is elastically deformed when the free ends swivel. The curved element forms a barrier that prevents the lip or cheek of a user from being pinched between the legs of the interdental cleaning device. In addition, the curved element assists in the restoring motion of the two legs into their swiveled-apart neutral position.

However, in the known interdental cleaning device it has proven disadvantageous that the curved element situated in the area of the free ends of the legs is very susceptible to material fatigue and material fracture due to the continual bending stress. In addition, the curved element results in a protruding design of the interdental cleaning device which makes handling difficult during dental care.

### SUMMARY OF THE INVENTION

The object of the present invention is to provide a preferably compact interdental cleaning device of the type mentioned at the outset, which is less susceptible to material fatigue.

To achieve the object, an interdental cleaning device having a one-piece, in particular injection-molded, base body is proposed, having a first leg and a second leg whose free ends are swivelable toward one another, wherein on its free end the first leg has a positioning aid, in particular a cone, that protrudes toward a cleaning side and surrounds an opening in the first leg, and on its free end the second leg has a mounting for an interdental brush that is guidable through the opening, wherein an elastic restoring element is situated between the first and the second leg, in a starting region of the legs situated opposite from the free ends of the legs.

In the interdental cleaning device according to the invention, an elastic restoring element via which the legs are resettable into a swiveled-apart neutral position is situated in the starting region of the legs. The legs of the base body may be brought from the neutral position into a swiveled-together cleaning position by a user of the interdental cleaning device, wherein the restoring element is elastically deformed, in particular elastically compressed. The legs of the base body may touch in the cleaning position. The arrangement of the elastic restoring element in the starting region of the legs, in which during swiveling between the neutral position and the cleaning position the legs move toward one another to a lesser degree than at their free ends, results in comparatively low deformation of the restoring element. Compared to a curved element that is situated at the free ends, the restoring element that is situated in the starting region of the legs is subjected to less compression or bending, and is therefore less susceptible to material fatigue. In addition, due to compressive stress via the legs of the base body, the restoring element does not deform up to the area of the free ends of the legs or even beyond these ends, so that a compact interdental cleaning device is obtained.

According to one advantageous embodiment of the invention, the elastic restoring element rests against the first leg and the second leg in such a way that an intermediate space between the first leg and the second leg in the starting region of the legs is completely filled by the restoring element. Since the restoring element fills the space between the legs in the starting region of the legs, swiveling together of the leg essentially results in compressive stress on the elastic restoring element. The elastic restoring element is particularly preferably designed in the manner of a wedge that is adapted to the shape of the intermediate space between the legs on the starting side.

It is advantageous for the base body to be designed in such a way that an intermediate space between the first leg and the second leg, beginning at their free ends in the direction of the starting region, tapers to a constriction, and widens, beginning at the constriction, in the direction of the starting region. The starting region of the legs is preferably curved in an arc, in particular a circular arc. The intermediate space between the legs may have an essentially circular cross section in the starting region of the legs, beginning at the constriction. In this regard, the starting region may be designed in the manner of an eyelet in the base body.

In this regard, it is preferred that the elastic restoring element, beginning at the starting region of the legs, extends to the side of the constriction opposite from the starting region. In this way, a form-fit connection may be achieved between the restoring element and the legs, which fixes the restoring element on the base body in a direction parallel to the main direction of extension of the legs.

The elastic restoring element is preferably made of a soft elastic plastic. The soft elastic plastic is particularly preferably a thermoplastic elastomer (TPE) or a silicone, so that the elastic restoring element may be manufactured by injection molding.

In addition, it has proven advantageous for the elastic restoring element to be made of a material having a Shore hardness A in the range of 30 to 80, preferably a Shore hardness A in the range of 50 to 70, particularly preferably a Shore hardness A in the range of 62 to 67. The restoring force that acts on the legs of the base body may be adjusted via the Shore hardness A of the material of the elastic restoring element.

According to one advantageous embodiment, the restoring element is detachably situated between the first and the second leg. The detachable arrangement of the restoring element between the legs of the base body has the advantage that the restoring element may be exchanged to adjust the restoring force that acts on the legs. For example, it is possible to provide an elastic restoring element having a greater Shore hardness A between the legs to obtain a greater restoring force, or to provide an elastic restoring element having a lower Shore hardness A to obtain a lower restoring force.

A first form-fit element that cooperates with a second form-fit element on the first or second leg is preferably situated on the elastic restoring element in order to fix the elastic restoring element between the legs. The first form-fit element situated on the restoring element is preferably designed as a recess, into which a second form-fit element designed as a projection on the first or the second leg engages. In this way a form-fit connection may be established between the restoring element and one of the legs, which prevents the restoring element from sliding out of the intermediate space between the legs in a direction perpendicular to a swivel direction of the legs in which the legs are swivelable. Alternatively, the first form-fit element may be provided on the restoring element as a projection that engages in a second form-fit element, designed as a recess, on the first or second leg The second form-fit element on the first or the second leg of the base body is particularly preferably provided in addition to the above-mentioned constriction in the intermediate space between the first and the second leg. According to another alternative, the form-fit element on the elastic restoring element may be designed as an outer edge of the restoring element, and the form-fit element on the base body may be designed as a step that cooperates with the outer edge.

Another preferred embodiment provides that the restoring element is formed in one piece with an in particular injection-molded coating of the base body. It is thus possible to manufacture the interdental cleaning device economically in a multicomponent injection molding process. This means that the base body, a coating of the base body, and the elastic restoring element may be molded in a single injection molding apparatus, wherein different materials may be used for the base body on the one hand, and for the coating and the elastic restoring element on the other hand. The restoring element, formed in one piece with the injection-molded coating, may be fixedly connected to the base body, so that inadvertent detachment of the elastic restoring element from the base body is prevented,

Furthermore, it is advantageous for the base body in the starting region of the legs to have an inlet opening that opens into the intermediate space between the first and the second leg. Within the scope of a multicomponent injection molding process, the liquefied material of the elastic restoring element may be introduced into the intermediate space between the legs of the base body through the inlet opening. The inlet opening may be designed, for example, as a groove in the base body.

To allow the best possible handling capability for the interdental cleaning device, the base body has an in particular rod-shaped handle area that adjoins the starting region of the legs. During the cleaning operation, the interdental cleaning device may be held in the handle area by a hand of the user.

An interdental brush is preferably situated on the mounting. The interdental brush advantageously has a fastening section that extends essentially at right angles to a cleaning section of the interdental brush. The interdental brush may be fastened to the mounting of the second leg via the fastening section. The cleaning section preferably has a brush element that is mounted in an in particular cylindrical mounting section. The cylindrical mounting section may be designed in such a way that it is introducible into the opening in the other leg.

According to one advantageous embodiment of the invention, a reinforcement element that is provided in one piece with the base body is situated in the starting region of the legs in such a way that a first intermediate space region is situated between the reinforcement element and the first leg, and a second intermediate space region is situated between the reinforcement element and the second leg. In this regard, the reinforcement element, as part of the base body, is made of the same material as the remainder of the base body. The elastic restoring element may surround the reinforcement element on several sides. The interior of the elastic restoring element may be reinforced by means of such a reinforcement element. The effects of undesirable contraction of the elastic restoring element over an extended service period of the interdental cleaning device may be mitigated in this way. The elastic restoring element preferably rests against the first leg and the second leg in such a way that the first intermediate space region between the reinforcement element and the first leg is completely filled by the elastic restoring element, and the second intermediate space region between the reinforcement element and the second leg is completely filled by the elastic restoring element. If the reinforcement element extends over only a portion of the width of the legs, a section of the intermediate space in the starting region of the legs between the first and second leg, in which no part of the restoring element is situated between the first and the second leg, may be completely filled by the restoring element.

A further subject matter of the invention relates to a method for manufacturing an interdental cleaning device, wherein a base body is injection-molded, the base body having a first leg and a second leg whose free ends are swivelable toward one another, wherein on its free end the first leg has a positioning aid, in particular a cone, that protrudes toward a cleaning side and surrounds an opening in the first leg, and on its free end the second leg has a mounting for an interdental brush that is guidable through the opening, wherein an elastic restoring element is situated between the first and the second leg, in a starting region of the legs that is situated opposite from the free ends of the legs.

The same advantages as explained above in conjunction with the interdental cleaning device according to the invention result with the manufacturing method.

According to one advantageous embodiment of the method, the elastic restoring element is detachably situated in the starting region of the legs. It is thus possible for the user of the interdental cleaning device him/herself to mount the elastic restoring element and/or remove a preinstalled restoring element between the legs of the base body and/or replace it with another elastic restoring element.

One alternative advantageous embodiment of the method provides that the elastic restoring element is cast onto the base body, in particular by means of a multicomponent injection molding process. Such an embodiment allows particularly economical manufacture of the interdental cleaning device in addition, the casting of the restoring element onto the base body may effectively prevent the restoring element from being unintentionally detached from the base body. The elastic restoring, element may be manufactured in the same method step as the coating of the base body in other areas of the base body.

In this regard, it has proven particularly advantageous for the material of the elastic restoring element to be introduced, in particular injected, through an inlet opening, in particular a groove, into the intermediate space between the legs in the starting region of the legs of the base body.

Further particulars, features, and advantages of the invention result from the drawings and from the following description of preferred embodiments with reference to the drawings. The drawings merely illustrate exemplary embodiments of the invention, which do not limit the concept according to the invention.

### BRIEF DESCRIPTION OF THE FIGURES

FIG. 1 shows a first exemplary embodiment of an interdental cleaning device according to the invention in a side view.

FIG. 2 shows the base body with a coating of the interdental cleaning device according to FIG. 1 in a side view.

FIG. 3 shows the elastic restoring element of the interdental cleaning device according to FIG. 1 in a schematic side view,

FIG. 4 shows the elastic restoring element of the interdental cleaning device according to FIG. 1 in a top view.

FIG. 5 shows a second exemplary embodiment of an interdental cleaning device according to the invention in a side view.

FIG. 6 shows the interdental cleaning device according to FIG. 5 in a perspective illustration.

FIG. 7 shows the interdental cleaning device according to FIG. 5 in a side view, with the interdental brush removed.

FIG. 8 shows the base body of he interdental cleaning device according to FIG. 5 in a side view.

FIG. 9 shows the base body according to FIG. 8 in a perspective illustration.

FIG. 10 shows a third exemplary embodiment of an interdental cleaning device according to the invention in a side view, the elastic restoring element not being illustrated.

FIG. 11 shows the interdental cleaning device according to FIG. 10 in a perspective illustration.

FIG. 12 shows the interdental cleaning device according to FIG. 10 in another perspective illustration.

### EMBODIMENTS OF THE INVENTION

Identical parts are always provided with the same reference numerals in the various figures, and therefore are generally designated or mentioned only once in each case.

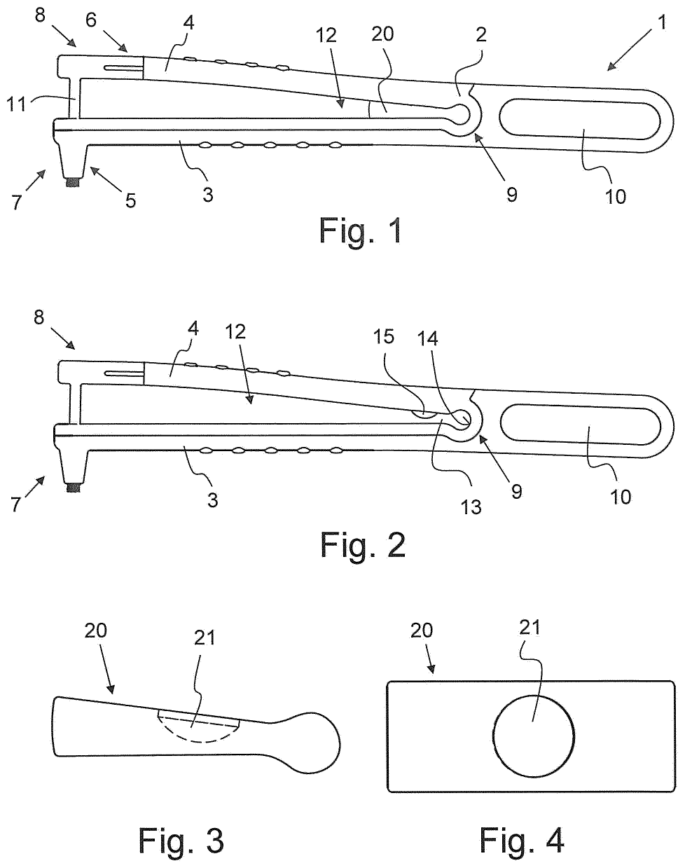

FIG. 1 illustrates an interdental cleaning device 1 according to a first exemplary embodiment of the invention. The interdental cleaning device 1 includes a one-piece base body 2 having a first leg 3 and a second leg 4. The two legs 3, 4 are connected to one another in one piece in a starting region 9 of the legs 3, 4. The starting region 9 of the legs 3, 4 is adjoined by a rod-shaped handle area 10 of the base body 2. The base body 2 is injection-molded from a hard component such as polypropylene (PP). The material of the base body 2 is selected in such a way that the base body 2 has a certain elasticity that allows the two legs to swivel from the neutral position shown in FIG. 1 into a cleaning position in which the legs are swiveled toward one another, in particular resting against one another. An angular difference of less than 20°, preferably less than 15°, particularly preferably less than 10°, for example, may be overcome between the neutral position and the cleaning position.

A positioning aid 5 that protrudes toward a cleaning side and surrounds an opening in the first leg 3 is situated on a free end 7 of the first leg 3, opposite from the starting region 9 of the legs 3, 4. The positioning aid 5 may be placed on the outer side of two adjacent teeth, and due to its shape facilitates the positioning of the opening in the area in front of the space between the two adjacent teeth. In the exemplary embodiment, the positioning aid 5 is designed as a cone. However, in a departure therefrom, other shapes of the positioning aid 5 are also conceivable in which the cross section of the positioning aid 5, beginning at the leg 3, tapers toward the cleaning side. The opening in the first leg 3 is designed as a through opening that extends from the cleaning side of the first leg 3, on which the positioning aid 5 is situated, to an opposite side.

The second leg 4 on its free end 8 opposite from the starting region 9 of the legs 3, 4 has a mounting 5 for an interdental brush 11. The interdental brush 11 may be guided through the opening in the first leg 3. The mounting 5 is situated on the second leg 4 in such a way that an interdental brush 11 that is fastened to the mounting 5 is guided through the opening in the first leg 3 when the second leg 4 swivels toward the first leg 3. When the legs 3, 4 are swiveled toward one another, the interdental brush 11 may exit from the opening on the cleaning side of the first leg 3 and penetrate into the space between the teeth to be cleaned.

To allow the legs 3, 4 to be returned to their swiveled-apart neutral position, in the interdental cleaning device 1 according to the first exemplary embodiment an elastic restoring element 20 is provided which in the starting region 9 of the legs 3, 4 is detachably situated between the first leg 3 and the second leg 4. The elastic restoring element 20 completely fills the intermediate space 12 between the first leg 3 and the second leg 4 in the starting region 9 of the legs 3, 4. The elastic restoring element 20 is made of a material that is softer than the base body 2. The material of the restoring element 20 is preferably a soft elastic plastic, for example a thermoplastic elastomer or a silicone, having a Shore hardness A in the range of 30 to 80, preferably having a Shore hardness A in the range of 50 to 70, particularly preferably having a Shore hardness A in the range of 62 to 67.

FIG. 2 shows the base body 2 of the interdental cleaning device 1 without the elastic restoring element 20. It is apparent that between the first leg 3 and the second leg 4 an intermediate space 12 is formed which, beginning at the free ends 7, 8 of the two legs 3, 4, tapers in the direction of the starting region 9 of the legs 3, 4 to a constriction 13. Beginning at the constriction 13, the intermediate space widens in the direction of the starting region 9, where it ends at a circular arch-shaped inner wall 14 of the base body 2. The intermediate space 12 has a circular cross section between the constriction 13 and the inner wail 14. In this regard, the intermediate space 12 between the constriction 13 and the inner wall 14 forms an eyelet.

In addition, a form-fit element 15 is situated on the second leg 4. The form-fit element 15 is designed as a projection that is situated on the inner side of the second leg 4 facing the intermediate space 12. The projection is provided in one piece with the second leg 4.

FIGS. 3 and 4 illustrate the elastic restoring element 20 detached from the base body 2. Situated on the elastic restoring element 20 is a further farm-fit element 21 that cooperates with the form-fit element 15 of the second leg 4 when the elastic restoring element 20 is introduced into the intermediate space 12 between the legs 3, 4. The form-fit element 21 of the restoring element 20 is designed as a recess in the restoring element 20. When the restoring element 20 is introduced into the intermediate space 12 in the starting region 9 of the legs 3, 4, the projection of the second leg 4 fills the recess in the restoring element 20 and fixes the restoring element 20 between the legs 3, 4. In addition, the restoring element 20 is fixed by a further form-fit connection to the constriction 13 of the intermediate space 12. This is because the restoring element 20, beginning at the starting region 9 of the legs 3, 4, extends to the side of the constriction 13 opposite from the starting region 9 and surrounds the constriction in a form-fit manner.

According to the first exemplary embodiment, the interdental cleaning device 1 may be manufactured by a method in which the base body 2 is initially injection-molded. In a further step, in the starting region 9 of the legs 3, 4 of the base body 2 the elastic restoring element 20 is arranged between the first leg 3 and the second leg 4. The arrangement of the restoring element 20 between the legs 3, 4 may take place during manufacture of the interdental cleaning device 1, i.e., before it is packaged. Alternatively, the restoring element 20 may be manufactured separately and introduced between the legs 3, 4 by a user of the interdental cleaning device 2. The user may selectively remove the detachable restoring element 20 from the base body 2 and replace it with another restoring element 20. By use of a suitable restoring element 20, it is thus possible in a user-specific manner to adjust the storing force that acts on the legs 3, 4. It has proven advantageous for restoring elements 20 to be color-coded, for example in such a way that restoring elements 20 having a certain Shore hardness A or having a certain restoring force are provided in a specified color. In addition, a worn-out restoring element 20 may be replaced with a new restoring element 20.

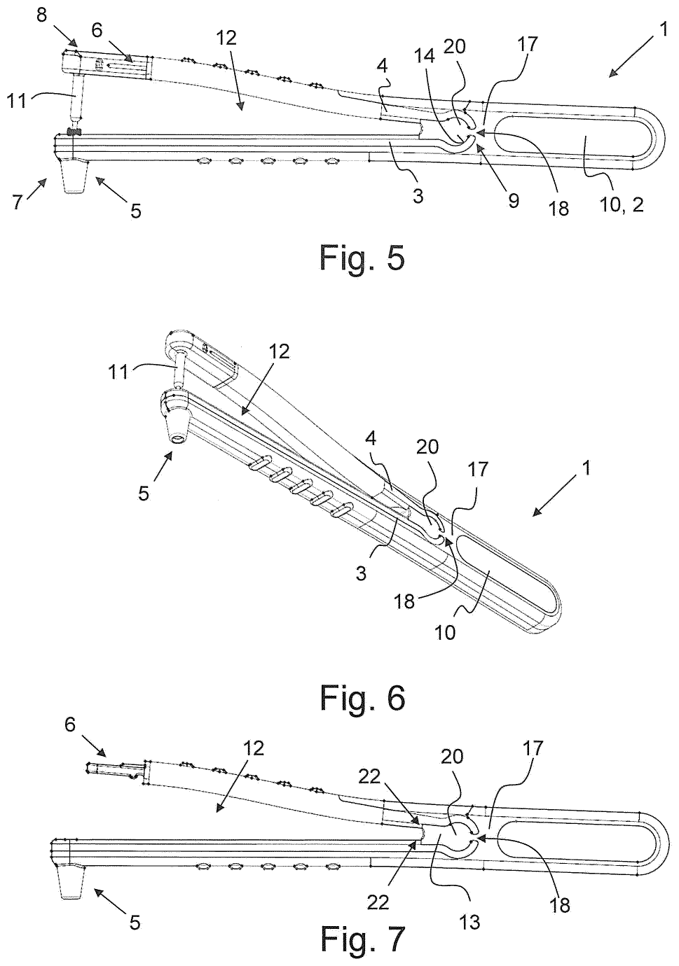

FIGS. 5, 6, and 7 show an interdental cleaning device 1 according to a second exemplary embodiment of the invention. This interdental cleaning device 1 also includes a one-piece base body 2 having a first leg 3, a second leg 4, and a rod-shaped handle area 10. The two legs 3, 4 are connected to one another in one piece and to the handle area 10 in a starting region 9 of the legs 3, 4. An intermediate space 12 is formed between the legs 3, 4 which, beginning at the free ends 7, 8 of the two legs 3, 4, tapers in the direction of the starting region 9 of the legs 3, 4 to a constriction 13. The base body 2 is injection-molded from a hard component such as polypropylene (PP). The base body 2 has a certain elasticity that allows the two legs to swivel from the neutral position shown in FIGS. 5 and 6 into a cleaning position in which the legs are swiveled toward one another, in particular resting against one another. An angular difference of less than 20°, preferably less than 15°, particularly preferably less than 10°, for example, may be overcome between the neutral position and the cleaning position.

The interdental cleaning device 1 according to the second exemplary embodiment likewise has a positioning aid 5 in the form of a cone that is situated on a free end 7 of the first leg 3. The positioning aid surrounds an opening in the first leg 3 through which an interdental brush 11 may be guided. On its free end 8 the second leg 4 has a mounting 5 for such an interdental brush 11. The interdental brush 11 may be guided through the opening in the first leg 3. The mounting 5 is situated on the second leg 4 in such a way that the interdental brush 11 fastened to the mounting 5 is guided through the opening in the first leg 3 when the second leg 4 is swiveled toward the first leg 3. When the legs 3, 4 are swiveled toward one another, the interdental brush 11 may exit from the opening on the cleaning side of the first leg 3 and penetrate into the space between the teeth to be cleaned.

Also for the interdental cleaning device 1 in the second exemplary embodiment, an elastic restoring element 20 is situated between the first leg 3 and the second leg 4, in the starting region 9 of the legs 3, 4 opposite from the free ends 7, 8 of the legs 3, 4. The restoring element 20 rests against the first leg 3 and the second leg 4 in such a way that the intermediate space 12 between the first leg 3 and the second leg 4 in the starting region 9 of the legs 3, 4 is completely filled by the restoring element 20. In the starting region 9, the intermediate space 12 is designed in the manner of an eyelet having a circular arch-shaped inner wall 14 of the base body 2. The intermediate space 12 has a circular cross section between the constriction 13 and the inner wall 14. In contrast to the first exemplary embodiment, the elastic restoring element 20 according to the second exemplary embodiment is fixedly connected to the base body 2 in particular to the legs 3, 4. For this purpose, the elastic restoring element 20 is formed in one piece with an injection-molded coating 17 of the base body 2. The coating 17 of the base body 2 is made of a soft elastic material, for example a thermoplastic elastomer or a silicone, having a Shore hardness A in the range of 30 to 80. In addition, the elastic restoring element 20, beginning at the starting region 9 of the legs 3, 4, extends to the side of the constriction 13 opposite from the starting region 9.

The interdental cleaning device 1 in the second exemplary embodiment may be manufactured by a method in which the base body 2 having the first leg 3 and the second leg 4 is injection-molded. In the starting region 9 of the legs 3, 4 the elastic restoring element 20 is cast onto the base body 2 between the first leg 3 and the second leg 4. A multicomponent injection molding process is used here. The formation of the elastic restoring element 20 takes place together with the formation of the coating 17 on the base body 2, so that the coating 17 and the restoring element 20 are formed in one piece.

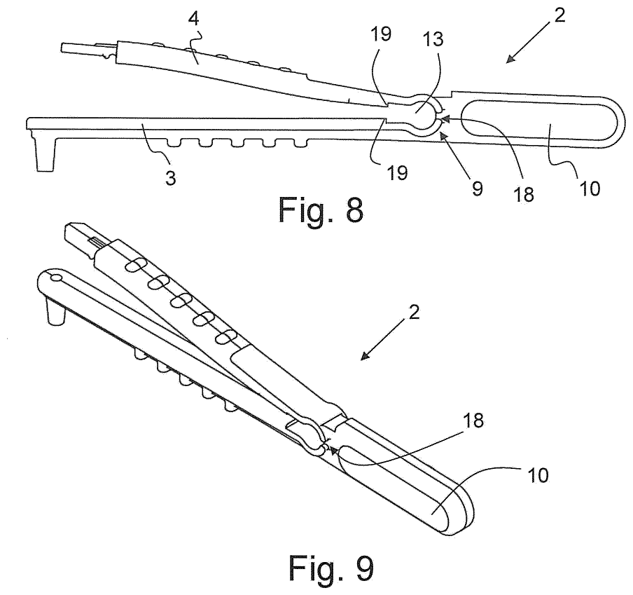

To facilitate the introduction of the liquefied material into the intermediate space 12 between the legs 3, 4 in order to form the restoring element 20, in the starting region 9 of the legs 3, 4 the base body 2 has an inlet opening 18 that opens into the intermediate space 12 between the first leg 3 and the second leg 4. As is apparent from the illustrations in FIGS. 8 and 9, the inlet opening 18 in the second exemplary embodiment is designed as a groove. Thus, during the manufacture of the interdental cleaning device 1, the material of the elastic restoring element 20 may be introduced into the intermediate space between the legs 3, 4 through the inlet opening 18 in the starting region 9 of the base body 2. It is also apparent that a form-fit element 19 is situated in each case on the first leg 3 and the second leg 4 of the base body 2. The form-fit elements 19 are designed in the manner of a step. The form-fit elements 19 on the base body 2 cooperate with form-fit elements 22 of the restoring element 20 that are designed as an outer edge, in order to additionally fix the elastic restoring element between the legs 3, 4 (see FIG. 7),

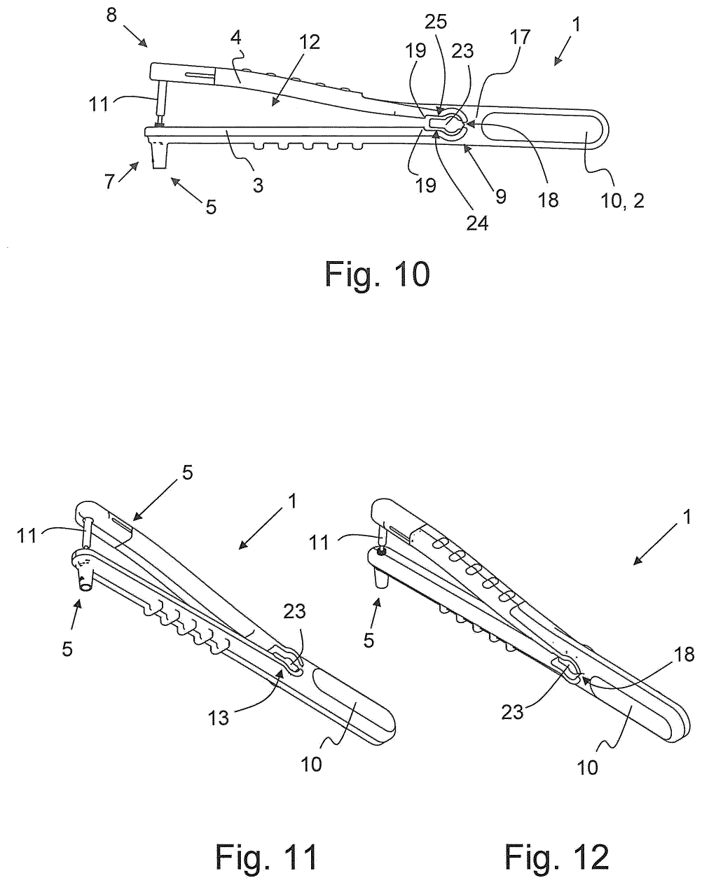

FIGS. 10, 11, and 12 illustrate a third exemplary embodiment of an interdental cleaning device according to the invention. This interdental cleaning device 1 also includes a one-piece base body 2 having a first leg 3, a second leg 4, and a rod-shaped handle area 10. The two legs 3, 4 are connected to one another in one piece and to the handle area 10 in a starting region 9 of the legs 3, 4. An intermediate space 12 is formed between the legs 3, 4 which, beginning at the free ends 7, 8 of the two legs 3, 4, tapers in the direction of the starting region 9 of the legs 3. 4 to a constriction 13. The base body 2 is injection-molded from a hard component such as polypropylene (PP). The base body 2 has a certain elasticity that allows the two legs to swivel from the neutral position shown in FIGS. 5 and 6 into a cleaning position in which the legs are swiveled toward one another, in particular resting against one another. An angular difference of less than 20°, preferably less than 15°, particularly preferably less than 10°, for example, may be overcome between the neutral position and the cleaning position.

The interdental cleaning device 1 according to the third exemplary embodiment likewise has a positioning aid 5 in the form of a cone that is situated on a free end 7 of the first leg 3. The positioning aid surrounds an opening in the first leg 3 through which an interdental brush 11 may be guided. On its free end 8 the second leg 4 has a mounting 5 for such an interdental brush 11. The interdental brush 11 may be guided through the opening in the first leg 3. The mounting 5 is situated on the second leg 4 in such a way that the interdental brush 11 fastened to the mounting 5 is guided through the opening in the first leg 3 when the second leg 4 is swiveled toward the first leg 3. When the legs 3, 4 are swiveled toward one another, the interdental brush 11 may exit from the opening on the cleaning side of the first leg 3 and penetrate into the space between the teeth to be cleaned.

Also for the interdental cleaning device 1 in the third exemplary embodiment, an elastic restoring element is situated between the first leg 3 and the second leg 4, in the starting region 9 of the legs 3, 4 opposite from the free ends 7, 8 of the legs 3, 4. For better visibility of the special features of the third exemplary embodiment, this restoring element is not shown in FIGS. 10, 11, and 12. The external appearance of this interdental cleaning device with an elastic restoring element corresponds to that of the second exemplary embodiment, so that in this regard, reference is made to the description of the second exemplary embodiment. In contrast to the preceding exemplary embodiments, a reinforcement element 23, provided in one piece with the base body 2, is situated in the starting region 9 of the legs 3, 4 in such a way that a first intermediate space region 24 is situated between the reinforcement element 23 and the first leg 3, and a second intermediate space region 25 is situated between the reinforcement element 23 and the second leg 4 The reinforcement element 23, as part of the base body 2, is thus made of the same material as the remainder of the base body 2. In the exemplary embodiment, the reinforcement element 23 is designed in the manner of a tongue that protrudes into the starting region 9 of the intermediate space 12. As is apparent from the illustrations in FIGS. 11 and 12, the width of the reinforcement element 23 is smaller than the width of the legs 3, 4. In this regard, the elastic restoring element, not shown in FIGS. 10, 11, and 12, may surround the reinforcement element 23 on several sides. In particular, the elastic restoring element rests against the first leg 3 and the second leg 4 in such a way that the first intermediate space region 24 between the reinforcement element 23 and the first leg 3 is completely filled by the elastic restoring element, and the second intermediate space region 25 between the reinforcement element 23 and the second leg 4 is completely filled by the elastic restoring element. Since the reinforcement element 23 extends over only a portion of the width of the legs 3, 4, the sections of the intermediate space 12 in the starting region 9 of the legs 3, 4 between the first leg 3 and second leg 4, in which no part of the restoring element 23 is situated between the first leg 3 and second leg 4, are completely filled by the restoring element.

In the starting region 9, the intermediate space 12 is designed in the manner of an eyelet having a circular arch-shaped inner wall 14 of the base body 2 The intermediate space 12 has a circular cross section between the constriction 13 and the inner wall 14. The same as for the second exemplary embodiment, the elastic restoring element is fixedly connected to the base body 2, in particular to the legs 3, 4. For this purpose, the elastic restoring element is formed in one piece with an injection-molded coating 17 of the base body 2.

The coating 17 of the base body 2 is made of a soft elastic material, for example a thermoplastic elastomer or a silicone, having a Shore hardness A in the range of 30 to 80. In addition, the elastic restoring element, beginning at the starting region 9 of the legs 3, 4, extends to the side of the constriction 13 opposite from the starting region 9.

The interdental cleaning device 1 in the third exemplary embodiment, the same as for the second exemplary embodiment, may be manufactured by a method in which the base body 2 having the first leg 3 and the second leg 4 is injection-molded. In the starting region 9 of the legs 3, 4 the elastic restoring element 20 is cast onto the base body 2 between the first leg 3 and the second leg 4. A multicomponent injection molding process is used here. The formation of the elastic restoring element takes place together with the formation of the coating 17 on the base body 2, so that the coating 17 and the restoring element 20 are formed in one piece. To facilitate the introduction of the liquefied material into the intermediate space 12 between the legs 3, 4 in order to form the restoring element 20, in the starting region 9 of the legs 3, 4 the base body 2 has an inlet opening 18 that opens into the intermediate space 12 between the first leg 3 and the second leg 4. In the third exemplary embodiment the inlet opening 18 is designed as a groove. Thus, during the manufacture of the interdental cleaning device 1, the material of the elastic restoring element may be introduced into the intermediate space between the legs 3, 4 through the inlet opening 18 in the starting region 9 of the base body 2 It is also apparent that a form-fit element 19 is situated in each case on the first leg 3 and the second leg 4 of the base body 2. The form-fit elements 19 are designed in the manner of a step. The form-fit elements 19 on the base body 2, the same as for the second exemplary embodiment, cooperate with form-fit elements 22 of the restoring element that are designed as an outer edge, in order to additionally fix the elastic restoring element between the legs 3, 4.

The interdental cleaning devices 1 described above each include a one-piece, in particular injection-molded, base body 2, having a first leg 3 and a second leg 4 whose free ends 7, 8 are swivelable toward one another. On its free end 7 the first leg 3 has a positioning aid 5, in particular a cone, that protrudes toward a cleaning side and surrounds an opening in the first leg 3. On its free end 8 the second leg 4 has a mounting 6 for an interdental brush 11 that is guidable through the opening. An elastic restoring element 20 is situated between the first and the second leg 3. 4, in a starting region 9 of the legs 3, 4 that is situated opposite from the free ends 7, 8 of the legs 3, 4. A compact interdental cleaning device 1 is thus obtained that is less susceptible to material fatigue.

### LIST OF REFERENCE NUMERALS

1 interdental cleaning device

2 base body

3 leg

4 leg

5 positioning aid

6 mounting

7 free end

8 free end

9 starting region

10 handle area

11 interdental brush

12 intermediate space

13 constriction

14 inner wall

15 form-fit element

17 coating

18 inlet opening

19 form-fit element

20 elastic restoring element

21 form-fit element

22 form-fit element

23 reinforcement element

24 intermediate space region

25 intermediate space region

1. An interdental cleaning device having a one-piece base body that has legs whose free ends are swivel able toward one another, the legs comprise a first leg and a second leg,
wherein a free end of the first leg has a positioning aid that is a cone that protrudes toward a cleaning side and surrounds an opening in the first leg,
wherein a free end of the second leg has a mounting for an interdental brush that is guidable through the opening of the first leg,
wherein an elastic restoring element is situated between the first leg and the second leg in a starting region of the legs situated opposite from the free ends of the legs.

2. The interdental cleaning device according to claim 1, wherein the elastic restoring element rests against the first leg and the second leg in such a way that an intermediate space between the first leg and the second leg in the starting region of the legs is completely filled by the restoring element.

3. The interdental cleaning device according to claim 1, wherein an intermediate space between the first leg and the second leg, beginning at the free ends of the legs in a direction of the starting region, tapers to a constriction, and then widens, beginning at the constriction, in the direction of the starting region.

4. The interdental cleaning device according to claim 3, wherein the elastic restoring element, beginning at the starting region of the legs, extends to side of the constriction opposite from the starting region.

5. The interdental cleaning device according to claim 1, wherein the elastic restoring element is made of a soft elastic plastic.

6. The interdental cleaning device according to claim 1, wherein the elastic restoring element is made of a material that has a Shore hardness A in a range of 30 to 80.

7. The interdental cleaning device according to claim 1, wherein the elastic restoring element is detachably situated between the first leg and the second leg.

8. The interdental cleaning device according to claim 1, wherein a first form-fit element that cooperates with a second form-fit element on the first leg or the second leg is situated on the elastic restoring element to fix the elastic restoring element between the legs.

9. The interdental cleaning device according to claim 1, wherein the elastic restoring element is formed in one piece with an injection-molded coating of the base body.

10. The interdental cleaning device according to claim 1, wherein the base body in the starting region of the legs has an inlet opening that is a groove, that opens into an intermediate space between the first leg and the second leg.

11. The interdental cleaning device according to claim 1, wherein the base body has a rod-shaped handle area that adjoins the starting region of the legs.

12. The interdental cleaning device according to claim 1, wherein a reinforcement element that is provided in one piece with the base body is situated in the starting region of the legs in such a way that a first intermediate space region is situated between the reinforcement element and the first leg, and a second intermediate space region is situated between the reinforcement element and the second leg.

13. The interdental cleaning device according to claim 12, wherein the elastic restoring element rests against the first leg and the second leg in such a way that the first intermediate space region between the reinforcement element and the first leg is completely filled by the elastic restoring element, and the second intermediate space region between the reinforcement element and the second leg is completely filled by the elastic restoring element.

14. A method for manufacturing an interdental cleaning device,
wherein the method comprises injection-molding a base body,
wherein the base body has legs whose free ends are swivel able toward one another, the legs comprises a first leg and a second leg,
wherein a free end of the first leg has a positioning aid, that is a cone, that protrudes toward a cleaning side and surrounds an opening in the first leg,
wherein a free end of the second leg has a mounting for an interdental brush that is guidable through the opening in the first leg,
wherein an elastic restoring element is situated between the first leg and the second leg in a starting region of the legs that is opposite from the free ends of the legs.

15. The method for manufacturing the interdental cleaning device according to claim 14, wherein the elastic restoring element is detachably situated in the starting region of the legs.

16. The method for manufacturing the interdental cleaning device according to claim 14, wherein the elastic restoring element is cast onto the base body by means of a multicomponent injection molding process.

17. The method for manufacturing the interdental cleaning device according to claim 16, wherein a material of the elastic restoring element is introduced or injected, through an inlet opening or a groove into the intermediate space between the legs in the starting region of legs.

18. The interdental cleaning device according to claim 1, wherein the body is injection molded.

19. The interdental cleaning device according to claim 5, wherein the soft elastic plastic is a thermoplastic elastomer or a silicone
